(19) United States
(12) Patent Application Publication
(10) Pub. No.: US 2023/0347936 A1
(43) Pub. Date: Nov. 2, 2023

(54) POWER SUPPLY METHOD AND POWER SUPPLY SYSTEM

(71) Applicant: TOYOTA JIDOSHA KABUSHIKI KAISHA, Toyota-shi (JP)

(72) Inventors: Taizo MASUDA, Yokohama-shi (JP); Yuta KATAOKA, Tokyo (JP); Yoshiki UEDA, Susono-shi (JP); Hiromitsu KOBAYASHI, Nisshin-shi (JP); Miki NOMOTO, Nisshin-shi (JP); Satoshi OMI, Ebina-shi (JP); Yuki NISHIKAWA, Susono-shi (JP)

(21) Appl. No.: 18/189,328

(22) Filed: Mar. 24, 2023

(30) Foreign Application Priority Data
May 2, 2022 (JP) 2022-076335

(51) Int. Cl. B60W 60/00

(52) U.S. Cl. CPC B60W 60/0025

(57) ABSTRACT

The power supply method includes: determining whether power supply to a power supply target is necessary; determining whether provision of a predetermined service by the autonomous driving electrified vehicle is stopped or service provision can be stopped; and supplying power from the autonomous driving electrified vehicle to the power supply target in response to determining that power supply to the power supply target is necessary and determining that service provision is stopped or service provision can be stopped.

### CROSS-REFERENCE TO RELATED APPLICATION

This application claims priority to Japanese Patent Application No. 2022-076335 filed on May 2, 2022, incorporated herein by reference in its entirety.

### BACKGROUND

### 1. Technical Field

The present disclosure relates to a power supply method and a power supply system.

### 2. Description of Related Art

There is known a power supply method in which power is supplied from a second electrified vehicle (EV) to a first electrified vehicle when the remaining power amount of a battery of the first electrified vehicle is insufficient with respect to the required amount of the first electric vehicle and the remaining power amount of a battery of the second electrified vehicle is surplus with respect to the required amount of the second electrified vehicle (for example, see Japanese Unexamined Patent Application Publication No. 2013-143875 (JP 2013-143875 A)).

A vehicle that provides a predetermined service is known. An example of such a vehicle includes a route bus. The route bus provides a passenger transportation service that is operated in accordance with a predetermined operation plan (such as route and time) to transport passengers.

### SUMMARY

The second electrified vehicle needs to be close to or adjacent to the first electrified vehicle during power supply. Thus, the second electrified vehicle needs to move or stop with the first electrified vehicle. Therefore, when the second electrified vehicle is, for example, a route bus, the route bus may no longer be able to operate in accordance with the operation plan. That is, when the vehicle providing the service supplies power to a power supply target, the service provision of the vehicle may be stopped or interrupted.

According to the present disclosure, the following are provided.

### Configuration 1

A power supply method includes: determining whether power supply to a power supply target is necessary; determining whether provision of a predetermined service by an autonomous driving electrified vehicle is stopped or whether the provision of the service is able to be stopped; and supplying power from the autonomous driving electrified vehicle to the power supply target in response to determining that the power supply to the power supply target is necessary and determining that the provision of the service is stopped or that the provision of the service is able to be stopped.

### Configuration 2

In the power supply method according to configuration 1, the service includes a transportation service for a passenger or a luggage.

### Configuration 3

In the power supply method according to configuration 1 or 2, when the service is a patrol service, determination is made that the provision of the service is able to be stopped.

### Configuration 4

The power supply method according to any one of configurations 1 to 3 further includes moving the autonomous driving electrified vehicle to the power supply target by autonomous driving prior to supplying power from the autonomous driving electrified vehicle to the power supply target.

### Configuration 5

The power supply method according to any one of configurations 1 to 4 further includes determining whether an available power supply amount of the autonomous driving electrified vehicle is sufficient for supplying power to the power supply target.
Power supply from the autonomous driving electrified vehicle to the power supply target is executed in response to a further determination that the available power supply amount of the autonomous driving electrified vehicle is sufficient for supplying power to the power supply target.

### Configuration 6

A power supply system includes: an autonomous driving electrified vehicle that provides a predetermined service; a power supply determination unit configured to determine whether power supply to a power supply target is necessary; a service determination unit configured to determine whether provision of the service by the autonomous driving electrified vehicle is stopped or whether the provision of the service is able to be stopped; and a power supply unit configured to supply power from the autonomous driving electrified vehicle to the power supply target in response to determining that the power supply to the power supply target is necessary and determining that the provision of the service is stopped or that the provision of the service is able to be stopped.

### Configuration 7

In the power supply system according to configuration 6, the service includes a transportation service for a passenger or a luggage.

### Configuration 8

In the power supply system according to configuration 6 or 7, the service determination unit is configured to determine that the provision of the service is able to be stopped when the service is a patrol service.

### Configuration 9

The power supply system according to any one of configurations 6 to 8 further includes a moving unit configured to move the autonomous driving electrified vehicle to the power supply target by autonomous driving prior to supplying power from the autonomous driving electrified vehicle to the power supply target.

### Configuration 10

The power supply system according to any one of configurations 6 to 9 further includes a power amount determination unit that determines whether an available power supply amount of the autonomous driving electrified vehicle is sufficient for supplying power to the power supply target.
The power supply unit is configured to supply power from the autonomous driving electrified vehicle to the power supply target in response to a further determination that the available power supply amount of the autonomous driving electrified vehicle is sufficient for supplying power to the power supply target.

It is possible to appropriately determine whether the power supply from the autonomous driving electrified vehicle to the power supply target can be executed in accordance with the state of service provision by the autonomous driving electrified vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic overview of a power supply system of an embodiment according to the present disclosure;

FIG. 2 is a schematic diagram of an autonomous driving electrified vehicle according to an embodiment of the present disclosure;

FIG. 3 is a schematic diagram of a powered object of an embodiment according to the present disclosure;

FIG. 4 is a schematic diagram of a server of an embodiment according to the present disclosure;

FIG. 5 is a schematic diagram illustrating a power supply method according to an embodiment of the present disclosure;

FIG. 6 is a flowchart illustrating a power supply control routine of an embodiment according to the present disclosure;

FIG. 7 is a flowchart illustrating a power supply control routine of another embodiment according to the present disclosure;

FIG. 8 is a functional block diagram of a server in an embodiment according to the present disclosure; and

FIG. 9 is a functional diagram of an autonomous driving electrified vehicle according to another embodiment of the present disclosure.

### DETAILED DESCRIPTION OF EMBODIMENTS

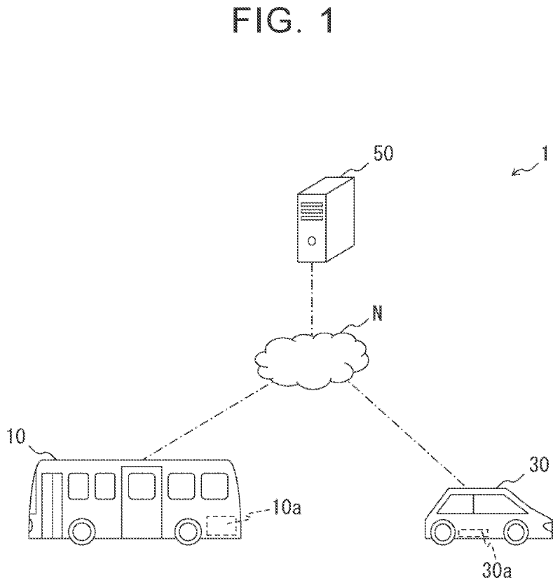

FIG. 1 schematically shows a power supply system 1 according to an embodiment of the present disclosure. Referring to FIG. 1, a power supply system 1 according to an embodiment of the present disclosure includes a power supply vehicle 10, a power supply target 30, and a server 50. In the embodiment according to the present disclosure, the power supply vehicle 10, the power supply target 30, and the server 50 can communicate with each other via a communication network N such as the Internet. Further, in the embodiment according to the present disclosure, power is supplied from the power supply vehicle 10 to the power supply target 30.

In the disclosed embodiment, the powered vehicle 10 is an autonomous driving electrified vehicle, i.e., an electrified vehicle (EV) that performs autonomous driving. An example of the autonomous driving electrified vehicle 10 is a large vehicle such as a bus. Another example of the autonomous driving electrified vehicle 10 includes a truck, a taxi, and the like. On the other hand, the power supply target 30 of the embodiment according to the present disclosure is an electrified vehicle that performs or does not perform automatic driving. An example of the power supply target 30 is a passenger car for private use or car sharing. In FIG. 1, the battery 10a of the autonomous driving electrified vehicle 10 and the battery 30a of the power supply target 30 are respectively illustrated.

An electrified vehicle according to an embodiment of the present disclosure includes an electric motor that drives a vehicle, and a battery that supplies power to the electric motor. In the disclosed embodiment, the battery 10a of the autonomous driving electrified vehicle 10 can be externally supplied, and the battery 30a of the power supply target 30 can be externally charged. Further, the capacity of the battery 10a of the autonomous driving electrified vehicle 10 is relatively large, and the capacity of the battery 30a of the power supply target 30 is relatively small.

Examples of the autonomous driving electrified vehicle 10 include a battery electric vehicle (BEV) provided with an electric motor without an internal combustion engine and driven by an electric motor supplied from an externally chargeable battery, a hybrid electric vehicle (HEV) driven by an electric motor supplied from an externally non-chargeable battery and an internal combustion engine, or driven by an electric motor supplied from an externally non-chargeable battery and supplied to a battery by a generator driven by the internal combustion engine, a plug-in hybrid electric vehicle (PHEV) in which a battery is an externally chargeable hybrid electric vehicle, and a fuel cell electric vehicle (FCEV) provided with an electric motor without an internal combustion engine and driven by an electric motor supplied from a battery supplied with a fuel cell. On the other hand, the power supply target 30 includes a battery electric vehicle (BEV), a plug-in hybrid electric vehicle (PHEV) in which the battery is an externally chargeable hybrid electric vehicle, and a fuel cell electric vehicle (FCEV).

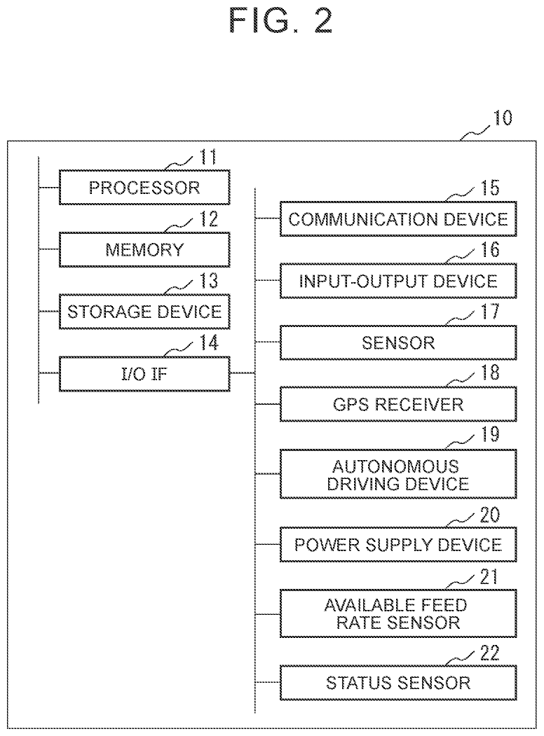

An autonomous driving electrified vehicle 10 according to an embodiment of the present disclosure comprises one or more processors 11, one or more memories 12, a storage device 13, and an input/output interface (IF)14), which are communicatively coupled to each other by bi-directional busses, as schematically illustrated in FIG. 2.

The memory 12 of the embodiments according to the present disclosure includes volatile or non-volatile memory. Various programs and the like are stored in the memory 12, and these programs are executed by the processor 11. The storage device 13 of the embodiment according to the present disclosure stores a calculation model, a travel route of the autonomous driving electrified vehicle 10, and the like.

A communication device 15, an input/output device 16, one or more sensors 17, a GPS receiver 18, an autonomous driving device 19, a power supply device 20, a possible power supply amount sensor 21, and a status sensor 22 are communicably connected to the input/output IF 14 of the embodiment.

The communication device 15 of the embodiment according to the present disclosure is communicably connected to the above-described communication network N. The input/output device 16 of the embodiment according to the present disclosure includes, for example, a keyboard, a mouse, a media reader/writer, an in-vehicle display, and the like. The sensor 17 includes a terrain sensor for detecting terrain information (e.g., sea level, height difference from the surroundings, and the like) at a position of the autonomous driving electrified vehicle 10 in addition to a camera, a LiDAR, and the like for autonomous driving. GPS receiver 18 of the disclosed embodiment receives signals from GPS satellites and thereby detects information representing the absolute position (e.g., longitude and latitude) of the autonomous driving electrified vehicle 10. An autonomous driving device 19 according to an embodiment of the present disclosure includes actuators that respectively perform driving, steering, and braking of the autonomous driving electrified vehicle 10.

The power supply device 20 supplies the electric power stored in the battery 10a of the autonomous driving electrified vehicle 10 to the outside of the autonomous driving electrified vehicle 10 in the form of a contact or a non-contact.

The possible power supply amount sensor 21 of the embodiment according to the present disclosure detects the possible power supply amount of the autonomous driving electrified vehicle 10. In one embodiment, the available power supply amount is the amount of power stored in the battery 10a of the autonomous driving electrified vehicle 10 minus the amount of power required after the autonomous driving electrified vehicle 10 has been powered (e.g., the amount of power required for the autonomous driving electrified vehicle 10 to return to the charging station). When the autonomous driving electrified vehicle 10 has a power generation function (for example, HEV, FCEV), the allowable power supply amount is obtained by subtracting the amount of electric power required after the autonomous driving electrified vehicle 10 has been supplied from the sum of the amount of electric power stored in the battery 10a of the autonomous driving electrified vehicle 10 and the amount of electric power that can be generated by the autonomous driving electrified vehicle 10.

The status sensor 22 of the embodiment according to the present disclosure detects the status of the service of the autonomous driving electrified vehicle 10. The status sensor 22 is, in one example, an in-vehicle camera for detecting whether a passenger or a luggage is present in the autonomous driving electrified vehicle 10.

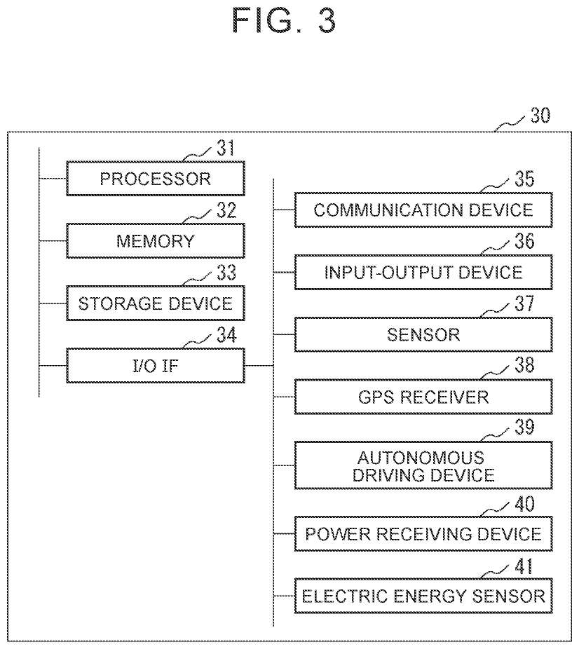

The power supply target 30 of the disclosed embodiment includes one or more processors 31, one or more memories 32, a storage device 33, and an input/output interface (IF) 34, which are communicatively coupled to each other by bi-directional busses, as schematically illustrated in FIG. 3.

A communication device 35, an input/output device 36, one or more sensors 37, a GPS receiver 38, an autonomous driving device 39, a power receiving device 40, and a power amount sensor 41 are communicably connected to the input/output IF 34.

The power receiving device 40 receives power from the outside of the power supply target 30 in a contact or non-contact manner, and supplies the power to the battery 30a of the power supply target 30. In the embodiment according to the present disclosure, the power receiving device 40 cooperates with the power supply device 20 of the autonomous driving electrified vehicle 10 to feed power from the autonomous driving electrified vehicle 10 to the power supply target 30.

The power amount sensor 41 detects the electric energy (or the charge rate SOC) of the battery 30a of the power supply target 30.

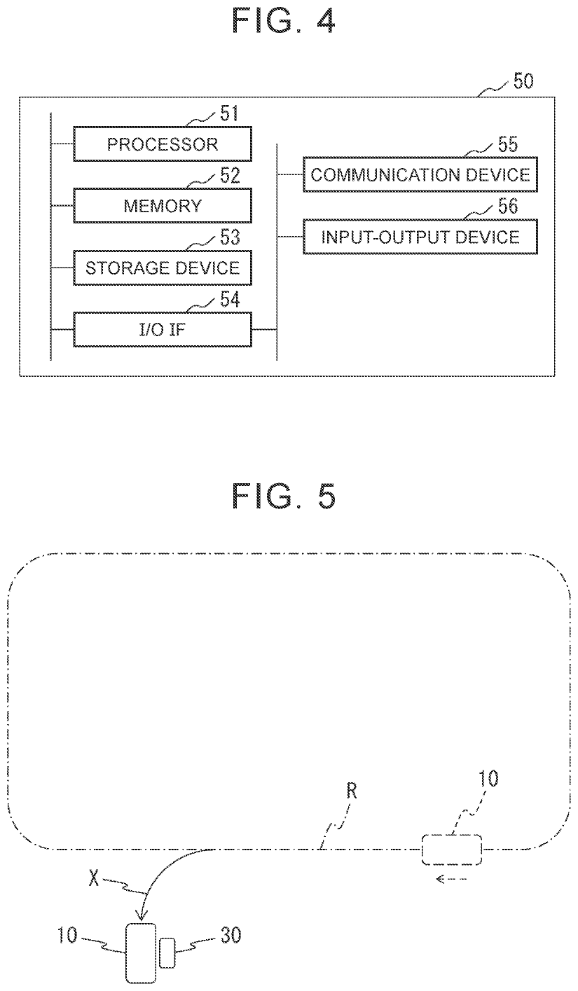

The server 50 of the disclosed embodiment comprises one or more processors 51, one or more memories 52, a storage device 53, and an input/output interface (IF)54), which are communicatively coupled to each other by bi-directional busses, as shown schematically in FIG. 4. A communication device 55 and an input/output device 56 are communicably connected to the input/output IF 54 of the embodiment.

In the embodiment according to the present disclosure, the processor 31, the memory 32, the storage device 33, the input/output IF 34, the communication device 35, the input/output device 36, the sensor 37, GPS receiver 38, and the autonomous driving device 39 of the power supply target 30 are the same as those of the processor 11, the memory 12, the storage device 13, the input/output IF 14, the communication device 15, the input/output device 16, the sensor 17, GPS receiver 18, and the autonomous driving device 19 of the autonomous driving electrified vehicle 10, and therefore, explanation thereof is omitted. Further, the processor 51, the memory 52, the storage device 53, the input/output IF 54, the communication device 55, the input/output device 56, and the sensor 57 of the server 5 are the same as those of the processor 11, the memory 12, the storage device 13, the input/output IF 14, the communication device 15, the input/output device 16, and the sensor 17 of the autonomous driving electrified vehicle 10, and therefore, explanation thereof is omitted.

The autonomous driving electrified vehicle 10 according to the embodiment of the present disclosure provides a predetermined service. For example, when the autonomous driving electrified vehicle 10 is a route bus, the autonomous driving electrified vehicle 10 is driven in accordance with a predetermined driving plan (route, time, and the like) to provide a passenger transportation service for transporting passengers. When the autonomous driving electrified vehicle 10 is a truck, the autonomous driving electrified vehicle 10 provides a luggage transportation service for transporting luggage. When the autonomous driving electrified vehicle 10 is a vehicle with a camera, the autonomous driving electrified vehicle 10 is driven in accordance with a predetermined driving plan (route, time, and the like) to provide a patrol service for patrolling the street.

Next, a power supply method according to an embodiment of the present disclosure will be described. The server 50 of the embodiment according to the present disclosure determines whether or not power supply to the power supply target 30 is necessary. In one embodiment, it is determined that the power supply to the power supply target 30 is necessary when the amount of power stored in the battery 30a of the power supply target 30 is smaller than a predetermined threshold value, and it is determined that the power supply to the power supply target 30 is not necessary when the amount of power stored in the battery 30a of the power supply target 30 is larger than the threshold value. In another embodiment, it is determined that the power supply to the power supply target 30 is necessary when the amount of power stored in the battery 30a of the power supply target 30 is smaller than the amount of power required for the power supply target 30 (for example, the amount of power required for the power supply target 30 to move to the destination), and it is determined that the power supply to the power supply target 30 is not necessary when the amount of power stored in the battery 30a of the power supply target 30 is larger than the amount of power required for the power supply target 30. In yet another example, when the power supply target 30 is a car sharing vehicle and there is a use reservation within a certain period of time, it is determined that power supply to the power supply target 30 is necessary, and when there is no use reservation, it is determined that power supply to the power supply target 30 is not necessary. Note that the power storage amount data of the battery 30a of the power supply target 30 or the required power amount data of the power supply target 30 are transmitted from the power supply target 30 to the servers 50 in advance. In the server 50, a required power supply amount of the power supply target 30 is calculated. The required power supply amount of the power supply target 30 is represented by a difference (>0) between the storage amount of the battery 30a of the power supply target 30 and the above-described threshold value in one example, and is represented by a difference (>0) between the storage amount of the battery 30a of the power supply target 30 and the required power amount of the power supply target 30 in another example.

In addition, the server 50 of the embodiment according to the present disclosure determines whether or not the possible power supply amount of the autonomous driving electrified vehicle 10 is sufficient for power supply to the power supply target 30. In an example, when the possible power supply amount of the autonomous driving electrified vehicle 10 is larger than the required power supply amount of the power supply target 30, it is determined that the possible power supply amount of the autonomous driving electrified vehicle 10 is sufficient for power supply to the power supply target 30, and when the possible power supply amount of the autonomous driving electrified vehicle 10 is smaller than the required power supply amount of the power supply target 30, it is determined that the possible power supply amount of the autonomous driving electrified vehicle 10 is not sufficient for power supply to the power supply target 30. Note that the available power supply amount data of the autonomous driving electrified vehicle 10 is transmitted from the autonomous driving electrified vehicle 10 to the server 50 in advance. In another example, it is determined that the possible power supply amount of the autonomous driving electrified vehicle 10 is sufficient for power supply to the power supply target 30 when the possible power supply amount of the autonomous driving electrified vehicle 10 is larger than the predetermined amount, and it is determined that the possible power supply amount of the autonomous driving electrified vehicle 10 is not sufficient for power supply to the power supply target 30 when the possible power supply amount of the autonomous driving electrified vehicle 10 is smaller than the predetermined amount.

Further, the server 50 of the embodiment according to the present disclosure determines whether the provision of the service of the autonomous driving electrified vehicle 10 is stopped or the provision of the service can be stopped. In the case where the autonomous driving electrified vehicle 10 is a route bus, in an example, the autonomous driving electrified vehicle 10 ends the driving according to the driving plan and returns to the vehicle base (garage), it is determined that the service provision is being stopped, and it is determined that the service provision is not being stopped when the autonomous driving electrified vehicle 10 is scheduled to perform the driving according to the driving plan or during the driving. Alternatively, when there is no passenger in the autonomous driving electrified vehicle 10 and there is no schedule (reservation) of passengers in the autonomous driving electrified vehicle 10, it is determined that the provision of the service can be stopped, and when there is a passenger in the autonomous driving electrified vehicle 10 or when there is a schedule of passengers in the autonomous driving electrified vehicle 10, it is determined that the provision of the service cannot be stopped. Note that information on whether or not the autonomous driving electrified vehicle 10 is driving in accordance with the driving plan, information on the presence or absence of a passenger in the autonomous driving electrified vehicle 10, and the like are transmitted in advance from the autonomous driving electrified vehicle 10 to the server 50.

Next, the server 50 of the embodiment according to the present disclosure determines that the power supply to the power supply target 30 is necessary, and determines that the possible power supply amount of the autonomous driving electrified vehicle 10 is sufficient for the power supply to the power supply target 30, and in response to determining that the provision of the service of the autonomous driving electrified vehicle 10 is stopped or that the provision of the service can be stopped, the server 50 controls the power supply device 20 of the autonomous driving electrified vehicle 10 and the power receiving device 40 of the power supply target 30 to supply power from the autonomous driving electrified vehicle 10 to the power supply target 30. In an example, the autonomous driving electrified vehicle 10 supplies the power supply target 30 with the required amount of electric power of the power supply target 30.

In addition, the server 50 of the embodiment according to the present disclosure controls the autonomous driving device 19 of the autonomous driving electrified vehicle 10 to move the autonomous driving electrified vehicle 10 to the power supply target 30 by automatic driving, prior to the power supply from the autonomous driving electrified vehicle 10 to the power supply target 30. In this case, the power supply target 30 is not moved. Next, when the autonomous driving electrified vehicle 10 moves to the power supply target 30, power supply from the autonomous driving electrified vehicle 10 to the power supply target 30 is executed. In another example, the server 50 moves the power supply target 30 to the autonomous driving electrified vehicle 10 by automatic driving without moving the autonomous driving electrified vehicle 10. In yet another example, the server 50 moves the autonomous driving electrified vehicle 10 and the power supply target 30 to a common power supply point by autonomous driving. The position information (for example, the absolute position) of the power supply target 30 or the autonomous driving electrified vehicle 10 is transmitted in advance from the power supply target 30 or the autonomous driving electrified vehicle 10 to the server 50.

As described above, in the embodiment according to the present disclosure, whether or not the power supply from the autonomous driving electrified vehicle 10 to the power supply target 30 can be executed is appropriately determined in accordance with the state of service provision by the autonomous driving electrified vehicle 10. Moreover, whether or not the power supply is executable is determined according to the therapy of the possible power supply amount of the autonomous driving electrified vehicle 10 and the state of service provision by the autonomous driving electrified vehicle 10. There is no such idea so far.

Further, in the embodiment according to the present disclosure, since the capacity of the battery 10a of the autonomous driving electrified vehicle 10 is relatively large, the power supply to the power supply target 30 can be reliably performed, and therefore, the power supply target 30 can be reliably rescued.

FIG. 5 schematically illustrates a power supply method of an embodiment according to the present disclosure. In the example of FIG. 5, the autonomous driving electrified vehicle 10 provides a service for transporting an occupant along the route R. When it is determined that the provision of the service can be stopped, as shown by X in FIG. 5, the autonomous driving electrified vehicle 10 deviates from the route R, moves to the power supply target 30, and supplies power to the power supply target 30.

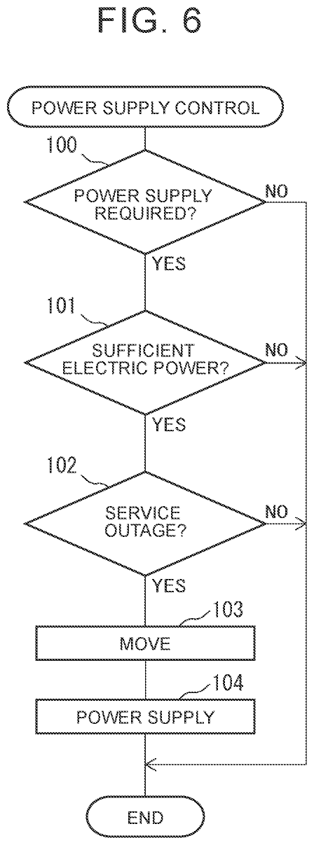

FIG. 6 illustrates a power supply control routine in an embodiment in accordance with the present disclosure. This routine is executed by the processor 51 of the server 50, for example. Referring to FIG. 6, in step 100, it is determined whether power supply to the power supply target 30 is necessary. When it is determined that the power supply to the power supply target 30 is necessary, the process proceeds to step 101, and it is determined whether or not the possible power supply amount of the autonomous driving electrified vehicle 10 is sufficient for the power supply to the power supply target 30. When it is determined that the possible power supply amount of the autonomous driving electrified vehicle 10 is sufficient for power supply to the power supply target 30, the process proceeds to step 102, and it is determined whether or not the provision of the service of the autonomous driving electrified vehicle 10 is stopped or the provision of the service can be stopped. When it is determined that the provision of the service of the autonomous driving electrified vehicle 10 is stopped or the provision of the service can be stopped, the process proceeds to step 103, and the autonomous driving electrified vehicle 10 is moved to the power supply target 30 by the autonomous driving. In the following step 104, power is supplied from the autonomous driving electrified vehicle 10 to the power supply target 30. On the other hand, when it is determined in step 100 that the power supply to the power supply target 30 is not necessary, when it is determined in step 101 that the possible power supply amount of the autonomous driving electrified vehicle 10 is not sufficient for the power supply to the power supply target 30, or when it is determined in step 102 that the provision of the service of the autonomous driving electrified vehicle 10 is stopped or that the provision of the service cannot be stopped, the processing cycle is ended.

Next, another embodiment according to the present disclosure will be described. To explain the differences from the embodiments according to the present disclosure described above, in another embodiment according to the present disclosure, the autonomous driving electrified vehicle 10 provides a passenger transportation service, for example, in the daytime, and provides a patrol service at night or at midnight.

In another embodiment according to the present disclosure, it is determined that the service provided by the autonomous driving electrified vehicle 10 can be stopped when the service is a patrol service. Alternatively, a determination is skipped as to whether the provision of the service is being stopped or the provision of the service can be stopped. In any case, the power supply to the power supply target 30 is given priority over the service provision.

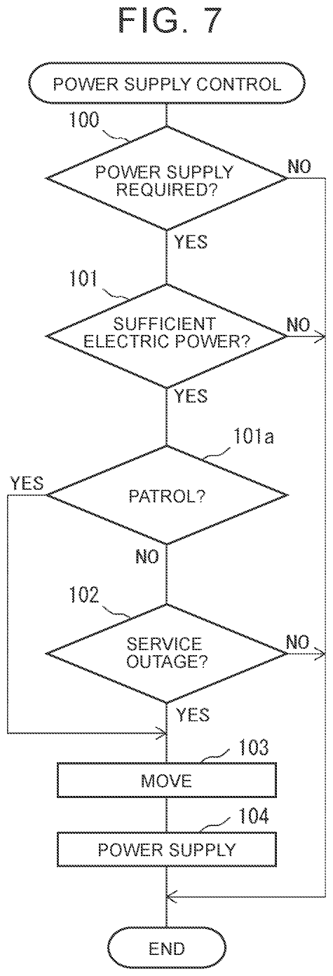

FIG. 7 illustrates a power supply control routine in another embodiment in accordance with the present disclosure. This routine is executed by the processor 51 of the server 50, for example. To explain the difference from the routine of FIG. 6, in the routine of FIG. 7, when it is determined in step 101 that the available power supply amount of the autonomous driving electrified vehicle 10 is sufficient for power supply to the power supply target 30, the process proceeds to the next step 101a, and it is determined whether or not the service provided by the autonomous driving electrified vehicle 10 is a patrol service. When it is determined that the service provided by the autonomous driving electrified vehicle 10 is the patrol service, the process then jumps to step 103. On the other hand, when it is determined that the service provided by the autonomous driving electrified vehicle 10 is not the patrol service, the process proceeds to step 102.

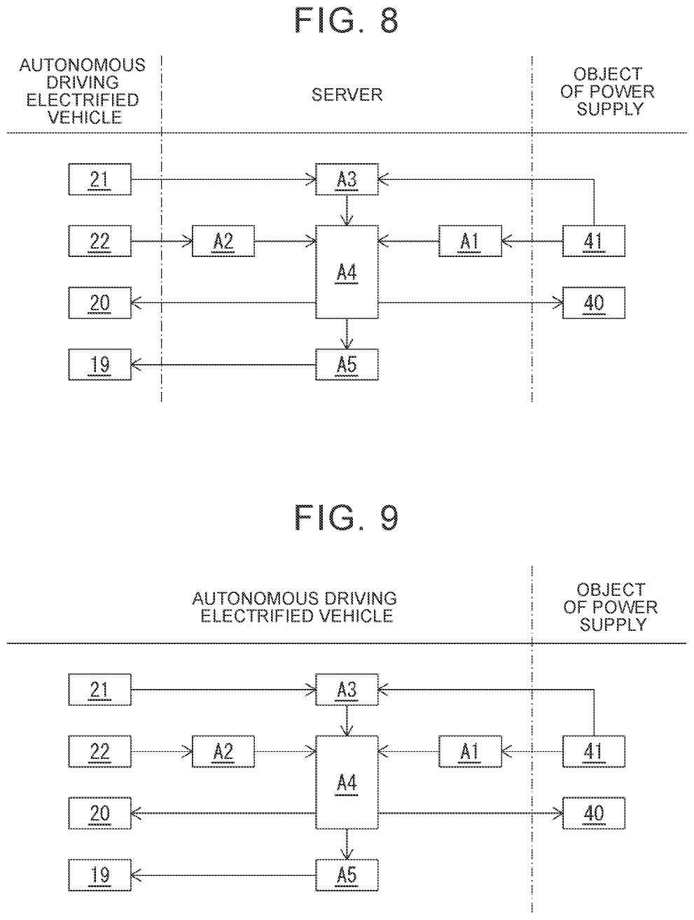

FIG. 8 is a functional block diagram of the processor 51 of the server 50 of the embodiment according to the present disclosure as described above. In the embodiment illustrated in FIG. 8, the processor 51 of the server 50 includes a power supply determination unit A1, a service determination unit A2, a power amount determination unit A3, a power supply unit A4, and a moving unit A5. The power supply determination unit A1 determines whether power supply to the power supply target 30 is required based on the power output of the power amount sensor 41 of the power supply target 30. The service determination unit A2 determines whether the provision of the service by the autonomous driving electrified vehicle 10 is stopped or the provision of the service can be stopped based on the output of the status sensor 22 of the autonomous driving electrified vehicle 10. The power amount determination unit A3 determines whether the possible power supply amount of the autonomous driving electrified vehicle 10 is sufficient for power supply to the power supply target 30 based on the power supply amount sensor 21 of the autonomous driving electrified vehicle 10 and the power amount sensor 41 of the power supply target 30. The power supply unit A4 controls the power supply device 20 of the autonomous driving electrified vehicle 10 and the power receiving device 40 of the power supply target 30 to supply power from the autonomous driving electrified vehicle 10 to the power supply target 30 in response to determining that power supply to the power supply target 30 is required and that the possible power supply amount of the autonomous driving electrified vehicle 10 is sufficient for power supply to the power supply target 30, and determining that the provision of the service of the autonomous driving electrified vehicle 10 is stopped or that the provision of the service can be stopped. The moving unit A5 controls the autonomous driving device 19 of the autonomous driving electrified vehicle 10 to move the autonomous driving electrified vehicle 10 to the power supply target 30 by the autonomous driving before supplying power from the autonomous driving electrified vehicle 10 to the power supply target 30.

In another embodiment, the processor 11 of the autonomous driving electrified vehicle 10 includes at least one of a power supply determination unit A1, a service determination unit A2, a power amount determination unit A3, a power supply unit A4, and a moving unit A5. In yet another embodiment, the processor 31 of the power supply target 30 includes at least one of a power supply determination unit A1, a service determination unit A2, a power amount determination unit A3, a power supply unit A4, and a moving unit A5.

FIG. 9 shows an exemplary embodiment in which the processor 11 of the autonomous driving electrified vehicle 10 includes all of the power supply determination unit A1, the service determination unit A2, the power amount determination unit A3, the power supply unit A4, and the moving unit A5. In this example, the server 50 is omitted. In addition, the autonomous driving electrified vehicle 10 and the power supply target 30 are connected to each other so as to be able to communicate with each other directly or through vehicle-to-vehicle communication.

In the embodiment according to the present disclosure described so far, the power supply target 30 is an electrified vehicle. In another embodiment, the power supply target 30 is a portable or stationary electronic device or electrical equipment (e.g., a smartphone, etc.).

What is claimed is:

1. A power supply method comprising:
determining whether power supply to a power supply target is necessary;
determining whether provision of a predetermined service by an autonomous driving electrified vehicle is stopped or whether the provision of the service is able to be stopped; and
supplying power from the autonomous driving electrified vehicle to the power supply target in response to determining that the power supply to the power supply target is necessary and determining that the provision of the service is stopped or that the provision of the service is able to be stopped.

2. The power supply method according to claim 1, wherein the service includes a transportation service for a passenger or a luggage.

3. The power supply method according to claim 1, wherein when the service is a patrol service, determination is made that the provision of the service is able to be stopped.

4. The power supply method according to claim 1, further comprising moving the autonomous driving electrified vehicle to the power supply target by autonomous driving prior to supplying power from the autonomous driving electrified vehicle to the power supply target.

5. The power supply method according to claim 1, further comprising determining whether an available power supply amount of the autonomous driving electrified vehicle is sufficient for supplying power to the power supply target, wherein power supply from the autonomous driving electrified vehicle to the power supply target is executed in response to a further determination that the available power supply amount of the autonomous driving electrified vehicle is sufficient for supplying power to the power supply target.

6. A power supply system comprising:
an autonomous driving electrified vehicle that provides a predetermined service;
a power supply determination unit configured to determine whether power supply to a power supply target is necessary;
a service determination unit configured to determine whether provision of the service by the autonomous driving electrified vehicle is stopped or whether the provision of the service is able to be stopped; and
a power supply unit configured to supply power from the autonomous driving electrified vehicle to the power supply target in response to determining that the power supply to the power supply target is necessary and determining that the provision of the service is stopped or that the provision of the service is able to be stopped.

7. The power supply system according to claim 6, wherein the service includes a transportation service for a passenger or a luggage.

8. The power supply system according to claim 6, wherein the service determination unit is configured to determine that the provision of the service is able to be stopped when the service is a patrol service.

9. The power supply system according to claim 6, further comprising a moving unit configured to move the autonomous driving electrified vehicle to the power supply target by autonomous driving prior to supplying power from the autonomous driving electrified vehicle to the power supply target.

10. The power supply system according to claim 6, further comprising a power amount determination unit that determines whether an available power supply amount of the autonomous driving electrified vehicle is sufficient for supplying power to the power supply target, wherein the power supply unit is configured to supply power from the autonomous driving electrified vehicle to the power supply target in response to a further determination that the available power supply amount of the autonomous driving electrified vehicle is sufficient for supplying power to the power supply target.
